(19) United States
(12) Patent Application Publication
(10) Pub. No.: US 2024/0160548 A1
(43) Pub. Date: May 16, 2024

(54) INFORMATION PROCESSING SYSTEM, INFORMATION PROCESSING METHOD, AND PROGRAM

(71) Applicant: SONY GROUP CORPORATION, TOKYO (JP)

(72) Inventors: KAORU AMEMIYA, TOKYO (JP); ITARU SHIMIZU, TOKYO (JP); SUGURU AOKI, TOKYO (JP); YOSHIYUKI KOBAYASHI, TOKYO (JP)

(21) Appl. No.: 18/550,136

(22) PCT Filed: Jan. 20, 2022
(86) PCT No.: PCT/JP2022/001896

§ 371 Date: Sep. 12, 2023

(30) Foreign Application Priority Data
Mar. 23, 2021 (JP) 2021-048706

(51) Int. Cl. G06F 11/28

(52) U.S. Cl. CPC G06F 11/28

(57) ABSTRACT

The present technology relates to an information processing system, an information processing method, and a program that make it possible to determine execution of learning, without relying on external instruction inputs. The information processing system determines an action on the basis of environmental information and a learning model obtained through learning based on an evaluation function for evaluating an action. The information processing system includes an error detection unit configured to determine a magnitude of a differential between the environmental information that has been newly input or the evaluation function that has been newly input and the environmental information that has existed or the evaluation function that has existed and a learning unit configured to update, depending on the magnitude of the differential, the learning model on the basis of the environmental information that has been newly input or the evaluation function that has been newly input and an amount of reward obtained for an action through the evaluation. The present technology can be applied to information processing systems.

### TECHNICAL FIELD

The present technology relates to an information processing system, an information processing method, and a program, in particular, to an information processing system, an information processing method, and a program that make it possible to determine execution of learning, without relying on external instruction inputs.

### BACKGROUND ART

Hitherto, there has been known reinforcement learning that takes environmental information indicating the surrounding environment or the like as an input and learns an appropriate action for that input.

As a technology related to reinforcement learning, for example, there has also been proposed a technology that uses, in addition to a state, an action, and a reward for an agent, sub-reward setting information based on annotations input by a user, to thereby achieve efficient reinforcement learning (for example, see PTL 1).

### CITATION LIST

### Patent Literature

### [PTL 1]

PCT Patent Publication No. 2018/150654

### SUMMARY

### Technical Problem

Incidentally, in recent years, there has been a demand for agents to automatically switch learning targets by themselves, that is, to autonomously determine whether to perform reinforcement learning for learning models or not, without relying on external instruction inputs.

However, in the technology described above, it has been necessary to prepare data and evaluation functions for learning for each time, and the agent has not been able to autonomously switch a learning target by itself.

The present technology has been made in view of such circumstances and makes it possible to determine the execution of learning, without relying on external instruction inputs.

### Solution to Problem

An information processing system according to an aspect of the present technology is an information processing system configured to determine an action on the basis of environmental information and a learning model obtained through learning based on an evaluation function for evaluating an action. The information processing system includes an error detection unit configured to determine a magnitude of a differential between the environmental information that has been newly input or the evaluation function that has been newly input and the environmental information that has existed or the evaluation function that has existed and a learning unit configured to update, depending on the magnitude of the differential, the learning model on the basis of the environmental information that has been newly input or the evaluation function that has been newly input and an amount of reward obtained for an action through the evaluation.

An information processing method or a program according to an aspect of the present technology is an information processing method or a program for an information processing system configured to determine an action on the basis of environmental information and a learning model obtained through learning based on an evaluation function for evaluating an action. The information processing method or the program includes steps of determining a magnitude of a differential between the environmental information that has been newly input or the evaluation function that has been newly input and the environmental information that has existed or the evaluation function that has existed and updating, depending on the magnitude of the differential, the learning model on the basis of the environmental information that has been newly input or the evaluation function that has been newly input and an amount of reward obtained for an action through the evaluation.

In an aspect of the present technology, in an information processing system configured to determine an action on the basis of environmental information and a learning model obtained through learning based on an evaluation function for evaluating an action, a magnitude of a differential between the environmental information that has been newly input or the evaluation function that has been newly input and the environmental information that has existed or the evaluation function that has existed is determined, and depending on the magnitude of the differential, the learning model is updated on the basis of the environmental information that has been newly input or the evaluation function that has been newly input and an amount of reward obtained for the action through the evaluation.

### BRIEF DESCRIPTION OF DRAWINGS

FIG. 1 is a diagram illustrating a learning model.

FIG. 2 is a diagram illustrating the present technology.

FIG. 3 is a diagram illustrating a configuration example of an information processing system.

FIG. 4 is a flowchart illustrating action determination processing.

FIG. 5 is a diagram illustrating exemplary actions depending on a magnitude of errors.

FIG. 6 is a diagram illustrating a configuration example of a computer.

### DESCRIPTION OF EMBODIMENT

Now, an embodiment to which the present technology is applied is described with reference to the drawings.

### First Embodiment

### <Learning Model>

The present technology makes it possible to determine execution of learning, without relying on external instruction inputs, that is, to automatically switch a learning target, by updating a learning model on the basis of a magnitude of the differential between newly input environmental information or reward information and existing environmental information or reward information.

First, a model (hereinafter referred to as a “learning model”) that is a target of reinforcement learning performed in the present technology is described.

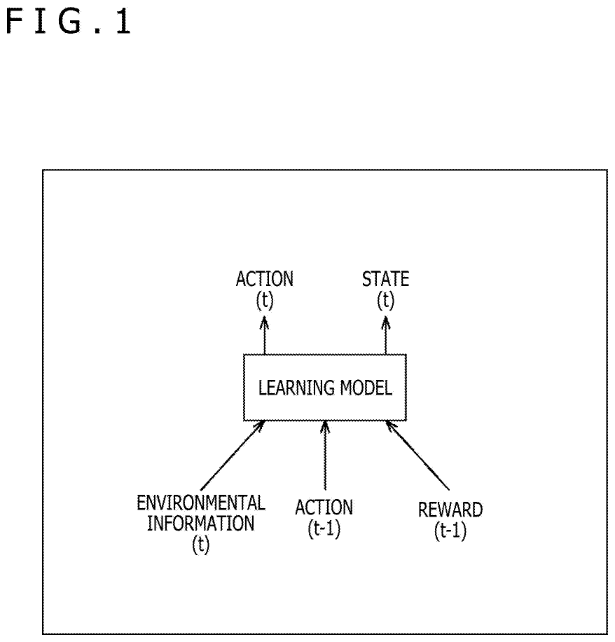

In the present technology, for example, as illustrated in FIG. 1, a learning model such as an LSTM (Long Short Term Memory) that takes environmental information, actions, rewards, and states as inputs and outputs is generated through reinforcement learning.

In this example, environmental information, which is information regarding the surrounding environment at a predetermined time t, the action (information indicating the action) at a time t−1 immediately before the time t, and the reward (information indicating the amount of reward) for the action at the time t−1 are input to the learning model.

The learning model performs predetermined calculations on the basis of the input environmental information, action, and reward, determines the action to be taken at the time t, and outputs the determined action (information indicating the action) at the time t and the state (information indicating the state) at the time t, the state changing due to the determined action.

Note that the state that serves as the output of the learning model refers to the state of an agent (information processing system) configured to take actions, the changes in the surrounding environment resulting from the actions, and the like.

In the present technology, the amount of reward given for an action, which serves as the output of the learning model, is changed depending on the action, that is, the state such as environmental changes in response to the action.

The learning model is associated with reward information including, for example, evaluation functions for evaluating the actions determined by the learning model.

This reward information is used for evaluating the action determined by the learning model and determining the amount of reward indicating the evaluation result, that is, determining how much reward to give for the action.

Further, the reward information also serves as information indicating an objective (goal) of the action determined by the learning model, that is, a task that serves as the target of reinforcement learning.

The amount of reward for the action determined by the learning model is determined by the evaluation function included in reward information. For example, the evaluation function can be a function that takes actions as inputs and outputs the amounts of reward. Besides, for example, a reward amount table in which actions and the amounts of reward given for the actions are associated may be included in reward information, and the amount of reward for an action may be determined on the basis of the reward amount table.

In the learning model, the past (previous) action and the amount of reward determined for the past (previous) action on the basis of reward information are used to determine the next (future) action, and hence it can be said that the reward information is also used to determine actions.

### <Reinforcement Learning>

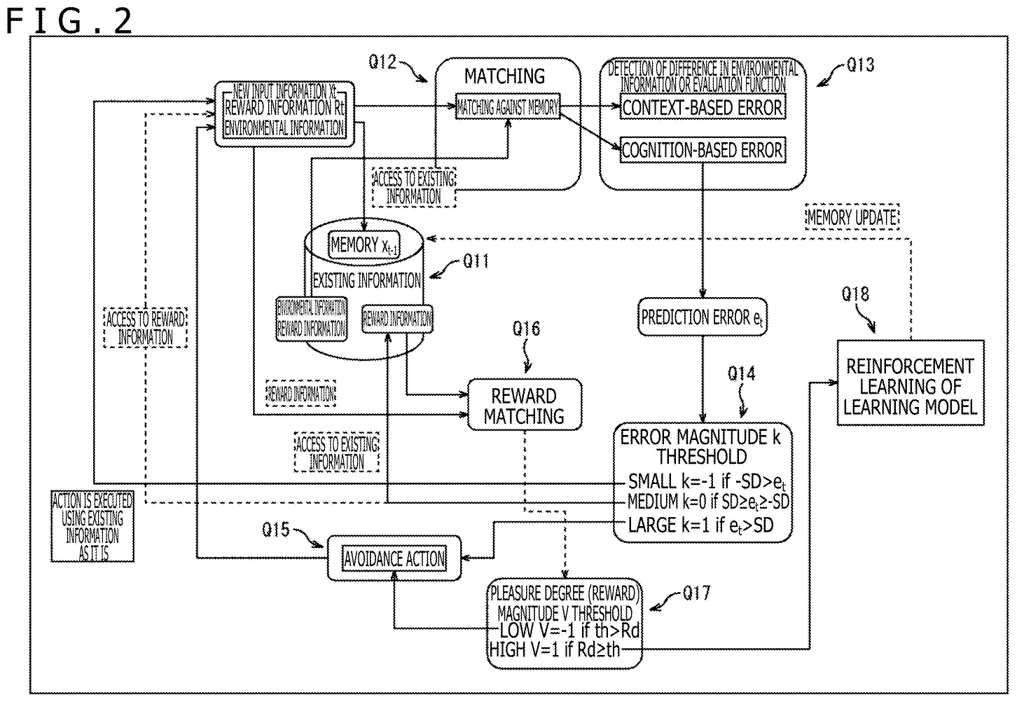

Next, with reference to FIG. 2, reinforcement learning performed in the information processing system to which the present technology is applied is described.

The information processing system to which the present technology is applied functions as an agent configured to perform reinforcement learning of the learning model described above and determine actions on the basis of the learning model, for example.

For example, the information processing system holds existing information as a past memory Xₜ₋₁, as indicated by an arrow Q11.

The existing information includes, for example, the learning model as well as the environmental information, reward information, selected action information indicating the action determined (selected) in the past, and the amount of reward given for the action indicated by the selected action information, that is, the evaluation result of the action, regarding the learning model in each past situation.

The environmental information included in the existing information refers to information regarding environment such as the surroundings of the information processing system. Specifically, for example, the environmental information is map information indicating a map of a predetermined city or information indicating sensing results such as information indicating images of the surroundings or arrangement position relations of surrounding objects obtained through sensing in a predetermined city or the like.

The reward information included in the existing information, that is, the existing reward information, is hereinafter also denoted by “Rₜ₋₁.” Further, the actions determined (selected) by the learning model are hereinafter also referred to as a “selected action.”

In the information processing system, when new input information Xₜ is supplied (input), access is made to the existing information, and the new input information Xₜ is matched against the existing information, that is, the past memory Xₜ₋₁, as indicated by an arrow Q12.

The new input information Xₜ is assumed to include at least any one of reward information Rₜ and environmental information each of which is the latest (newest) information at the moment.

The reward information or environmental information included in the new input information Xₜ may be the same as existing reward information or environmental information serving as existing information, or may be updated reward information or environmental information different from those in the existing information.

When the new input information Xₜ is input, among the existing information, past reward information or environmental information which is the closest, that is, the most similar, to the reward information or environmental information included in the new input information Xₜ is read.

Then, the read past reward information (evaluation function) or environmental information is matched against (compared with) the reward information or environmental information included in the new input information Xₜ. For example, during matching, the difference (differential) between the past (existing) reward information or environmental information and the new reward information or environmental information is detected.

Note that, here, as matching processing, an example in which the new input information Xₜ is matched against the past memory Xₜ₋₁ is described.

However, the present technology is not limited to this. The situation at this time may be estimated from the new input information Xₜ and the past memory Xₜ₋₁ (existing information), and the estimation result, that is, an expected value Ct, may be matched against the new input information Xₜ. In this case, for example, environmental information, reward information, an action, or the like is estimated as the expected value Ct.

When the new input information Xₜ is matched against the past memory Xₜ₋₁, then, as indicated by an arrow Q13, the difference, more specifically, the magnitude of the differential, in environmental information or reward information (evaluation function) is detected on the basis of the matching result, and a prediction error eₜ is generated on the basis of the detection result.

In difference detection, at least any one of a context-based error (hereinafter also referred to as a “context-based prediction error”), which is caused by environmental information, and a cognition-based error (hereinafter also referred to as a “cognition-based prediction error”), which is caused by evaluation functions (reward information), is detected.

The context-based prediction error is an error due to environment-dependent contextual discrepancies such as unfamiliar places or context or sudden changes in known context. The context-based prediction error is used for detecting new environmental information, that is, new environmental variables or changes in known environmental variables, and reflecting (incorporating) the new environmental information in the learning model or the like.

Specifically, for example, the context-based prediction error is information indicating the magnitude of the differential between new environmental information and existing environmental information. The context-based prediction error is determined on the basis of the difference (differential) between new environmental information serving as the new input information Xₜ and existing environmental information serving as the past memory Xₜ₋₁.

The cognition-based prediction error is an error due to cognitive conflicts such as gaps from what is known or predictable (information discrepancy). This cognition-based prediction error is used for reducing the use of known evaluation functions, as well as detecting new evaluation functions and reflecting (incorporating) the new evaluation functions in the learning model or the like, in situations where errors (conflicts) occur such as when tasks unsolvable by the existing method (learning model) occur. That is, in a case where a cognition-based prediction error is detected, reinforcement learning (update) is performed to obtain a learning model in which new evaluation functions are used and the use of existing evaluation functions is reduced.

Specifically, for example, the cognition-based prediction error is information indicating the magnitude of the differential between a new evaluation function and an existing evaluation function. The cognition-based prediction error is determined on the basis of the difference (differential) between a new evaluation function serving as the new input information Xₜ and an existing evaluation function serving as the past memory Xₜ₋₁.

In the information processing system, the final prediction error eₜ is determined on the basis of at least any one of the context-based prediction error and the cognition-based prediction error.

The prediction error eₜ indicates the magnitude of the differential between the environmental information or reward information (evaluation function) newly input as the new input information Xₜ and existing environmental information or reward information (evaluation function) serving as existing information. In other words, it can also be said that the prediction error eₜ is the magnitude of an uncertainty factor in determining an action for the new input information Xₜ on the basis of the existing information.

Specifically, for example, in a case where only any one of a context-based prediction error and a cognition-based prediction error has a value other than zero, that is, in a case where only any one of a context-based prediction error and a cognition-based prediction error is detected, the value of the detected error is regarded as the prediction error eₜ.

Further, for example, the total prediction error obtained by performing some calculations on the basis of context-based prediction errors and cognition-based prediction errors may be regarded as the prediction error eₜ.

Moreover, for example, in a case where both the context-based prediction error and the cognition-based prediction error are detected, the value of the predetermined one (the one with higher priority) of those prediction errors may be regarded as the prediction error eₜ.

Note that the context-based prediction error, the cognition-based prediction error, and the prediction error eₜ may be scalar values, vector values, distributions of errors, or the like. However, in the following, for the sake of simplicity in the description, the context-based prediction error, the cognition-based prediction error, and the prediction error eₜ are assumed to be scalar values.

When the prediction error eₜ is determined, in the information processing system, as indicated by an arrow Q14, the prediction error eₜ is compared with a predetermined threshold ±SD to discriminate the magnitude of the prediction error eₜ. In this example, the magnitude of the prediction error eₜ (error magnitude k) is classified as “small,” “medium,” or “large.”

That is, in a case where the prediction error eₜ is less than −SD, the error magnitude k is classified as “small,” which indicates that the prediction error eₜ is small. The error magnitude “small” indicates that the magnitude of the prediction error eₜ is small enough to allow, in resolving new tasks (determining actions), the tasks to be resolved without problems by applying the existing learning model.

Further, in a case where the prediction error eₜ is equal to or greater than −SD and equal to or less than SD, the error magnitude k is classified as “medium,” which indicates that the prediction error eₜ is moderate. The error magnitude “medium” indicates that the prediction error eₜ is large enough to cause, in resolving new tasks, problems with the output obtained by applying the existing learning model, but is still within a range in which reinforcement learning of the learning model is possible. In a case where the prediction error eₜ is greater than SD, the error magnitude k is classified as “large,” which indicates that the prediction error eₜ is large. The error magnitude “large” indicates that the prediction error eₜ is predicted to be large enough to make, in resolving new tasks, learning unsuccessful, that is, convergence of learning be difficult to perform, even when learning is performed on the basis of the new input (new input information).

In the information processing system, depending on the error magnitude k obtained as a result of such discrimination, it is determined whether or not to update the existing learning model by using the new input information Xₜ, that is, whether or not to perform reinforcement learning of the learning model.

That is, the information processing system (agent) autonomously determines the execution of reinforcement learning of the learning model on the basis of the error magnitude k, without relying on external instruction inputs. In other words, the learning target is automatically switched by the information processing system (agent).

Specifically, in a case where the error magnitude k is “small,” reinforcement learning of the learning model is not performed. An action is executed using the existing information as it is, and then the input of the next new input information Xₜ, that is, exploration of new learning (new task), is requested.

The error magnitude k is “small” in a case where, for example, the difference between the new input information Xₜ and the past memory Xₜ₋₁ is small, that is, the new reward information or environmental information is exactly the same as or almost the same as the existing reward information or environmental information.

Thus, in such cases, for example, the selected action indicated by the selected action information held as existing information can be selected as it is as the action determined for the new input information Xₜ. Further, for example, on the basis of the existing learning model and environmental information or reward information serving as the new input information Xₜ, an action for the new input information Xₜ may be determined.

Further, in a case where the error magnitude k is “large,” in the information processing system, as indicated by an arrow Q15, reinforcement learning of the learning model is not performed, and an avoidance action is taken. Moreover, the input of the next new input information Xₜ, that is, exploration of new learning (new task), is then requested.

For example, in a case where the error magnitude k is “large,” there is a possibility that the prediction error eₜ, that is, the uncertainty factor, is too large and it is impossible to select an appropriate action even by the learning model subjected to reinforcement learning. In other words, there is a possibility that it is difficult for the information processing system to resolve the task indicated by the new input information Xₜ.

Thus, in the information processing system, reinforcement learning of the learning model is not performed, that is, execution of reinforcement learning is inhibited, and as processing corresponding to an avoidance action, for example, the processing of requesting another system to select an action for the new input information Xₜ is performed.

In this case, after the avoidance action, the input of the next new input information Xₜ, that is, exploration of new learning (new task), is requested, and the processing shifts (transitions) to new reinforcement learning of the learning model.

Besides, for example, the processing of determining an action for the new input information Xₜ on the basis of the existing learning model and environmental information or reward information serving as the new input information Xₜ, and presenting the determined action to a user may be performed as processing corresponding to an avoidance action. In such a case, whether to actually execute the determined action or not is selected by the user.

Moreover, for example, in a case where the error magnitude k is “medium,” in the information processing system, proximity (preference) to execution of reinforcement learning of the learning model is induced. As indicated by an arrow Q16, reward (reward information) matching is performed to determine a pleasure degree Rd (pleasure level).

Note that it is preferred that the calculation method and the threshold SD for the prediction error eₜ be set such that cognition-based prediction errors are taken as more difficult than context-based prediction errors, that is, proximity to execution of reinforcement learning is induced more easily for cognition-based prediction errors than for context-based prediction errors. Further, such a setting may be achieved by adjusting the distribution of errors serving as context-based prediction errors or cognition-based prediction errors.

In the portion indicated by the arrow Q16, reward (reward information) matching is performed.

That is, the reward information Rₜ serving as the new input information Xₜ and the existing reward information Rₜ₋₁ included in the existing information are read, and the pleasure degree Rd is determined on the basis of the reward information Rₜ and the reward information Rₜ₋₁.

The pleasure degree Rd indicates an error (difference) in the amounts of reward obtained for actions, which is determined from the reward information Rₜ and the reward information Rₜ₋₁. More specifically, the pleasure degree Rd indicates a difference (error) between the amount of reward predicted on the basis of the environmental information or reward information Rₜ (evaluation function) newly input as the new input information Xₜ and the amount of reward predicted on the basis of the existing information such as the existing reward information Rₜ₋₁.

For example, as the error of the amount of reward increases, the pleasure degree Rd increases, leading to positiveness to execution of reinforcement learning.

In other words, when the pleasure degree Rd is high, a positive reward is obtained for resolving a task corresponding to the new input information Xₜ (reinforcement learning of the learning model), while, when the pleasure degree Rd is low, a negative reward is obtained for resolving a task.

Such a pleasure degree Rd mimics human psychology (curiosity) that humans become more proactive (positive) with a higher pleasure degree when obtaining more rewards.

For example, the pleasure degree Rd may be calculated by estimating, with regard to the reward information Rₜ and the reward information Rₜ₋₁, the amounts of reward obtained for approximately the same conditions or action with the new input information Xₜ, and determining the differential or the like between the estimated amounts of reward. The pleasure degree Rd may be calculated using other methods.

Further, for example, in the calculation of the pleasure degree Rd, the evaluation result (amount of reward) for the past selected action included in the existing information may be used as it is, or the action and the amount of reward for the new input information Xₜ may be estimated from that evaluation result, and the estimation result may be used to calculate the pleasure degree Rd.

Besides, in the calculation of the pleasure degree Rd, not only the amount of reward based on reward information but also the negative reward predicted on the basis of the new input information Xₜ and the existing information, that is, a magnitude of risk, may be considered, as well as the positive reward. In this case, the negative reward may also be determined from the reward information, or the negative reward may be predicted on the basis of other information.

When the pleasure degree Rd is determined, in the information processing system, as indicated by an arrow Q17, the pleasure degree Rd is compared with a predetermined threshold th to discriminate a magnitude of the pleasure degree Rd. In this example, the magnitude of the pleasure degree Rd (pleasure degree magnitude V) is classified as “low” or “high.”

That is, in a case where the pleasure degree Rd is less than the threshold th, the pleasure degree magnitude V is classified as “low,” which indicates that the pleasure degree Rd is low (small), that is, the obtained reward is negative.

In contrast to this, in a case where the pleasure degree Rd is equal to or greater than the threshold th, the pleasure degree magnitude V is classified as “high,” which indicates that the pleasure degree Rd is high (large), that is, the obtained reward is positive.

In a case where the pleasure degree magnitude V is “low,” since the reward obtained for resolving the task is negative, reinforcement learning of the learning model is not performed, and the avoidance action indicated by the arrow Q15 is taken, similar to the case where the error magnitude k is “large.”

On the other hand, in a case where the pleasure degree magnitude V is “high,” since the reward obtained for resolving the task is positive, an action for proximity to resolving the task is induced. That is, as indicated by an arrow Q18, reinforcement learning of the learning model included in the existing information is performed on the basis of the new input information Xₜ. At this time, new environmental information or the like is appropriately acquired as data for reinforcement learning.

In reinforcement learning of the learning model, a gradient (coefficient) of network nodes that form the learning model, which takes environmental information, the action at this time, and the amount of reward for the action at this time as inputs and outputs the next action and environmental changes (state) due to the next action, is updated.

At this time, a weighting of learning for reinforcement learning may be changed depending on the pleasure degree magnitude V, that is, a magnitude of curiosity.

It has been found that the memory of humans for objects of curiosity is facilitated and consolidated. Since the state in which reinforcement learning is performed is a state of high curiosity, changing, depending on the pleasure degree magnitude V, the weighting of learning creates a behavior that mimics such a relation between curiosity and memory, thereby making it possible to obtain a learning model configured to select actions in a way closer to humans.

In the information processing system, when reinforcement learning of the learning model is performed, the memory is updated.

That is, the existing information is updated such that the learning model obtained through reinforcement learning, that is, the post-update learning model, and the new input information Xₜ (environmental information and reward information) input this time are included in the existing information as new memories. At this time, the pre-update learning model included in the existing information is replaced by the post-update learning model.

Note that, during reinforcement learning, self-monitoring that performs learning while sequentially verifying the current situation, which includes selected actions, environmental changes (state), and the like, and updating the prediction error eₜ may be performed.

Further, in the information processing system, a counter for how many times the action determined on the basis of the learning model has been performed may be included.

In this case, the smaller the value of the counter, the more the information processing system (agent) is curious about reinforcement learning (task resolution) without getting bored with the action. Conversely, a large value of the counter indicates the state in which the information processing system has repeated the action too many times and got bored with the action, that is, has adapted to the stimulus.

Thus, in a case where the value of the counter is less than a predetermined threshold, reinforcement learning of the learning model may be continuously performed, and in a case where the value of the counter is equal to or greater than the threshold, the reinforcement learning may be terminated, and the avoidance action indicated by the arrow Q15 may be taken.

Even without such a counter, since, when reinforcement learning of the learning model is repeatedly performed, the error magnitude k and the pleasure degree magnitude V are changed every time the new input information Xₜ is newly input, processing that mimics adaptation (boredom) to stimuli is achieved. Specifically, for example, when the error magnitude k becomes “small” due to repeated reinforcement learning, the reinforcement learning is no longer performed, resulting in the same behavior as that in a bored state.

As described above, it can be said that selecting avoidance actions or determining the execution of reinforcement learning, depending on the error magnitude k, that is, the magnitude of the uncertainty factor, or the pleasure degree magnitude V is close to an actual human behavior.

The following have been found regarding the human brain: learning is driven to correct the prediction error between actual sensory feedback corresponding to the action taken in response to a motor command and sensory feedback predicted from the motor command, and moderate prediction errors are preferred. This corresponds to inducing proximity to reinforcement learning in a case where the error magnitude k is “medium” in the information processing system.

Further, the following have been found regarding the human brain: the pleasure level related to reward prediction errors is correlated with the avoidance network (ventromedial prefrontal cortex and posterior cingulate gyrus), and a high pleasure level promotes proximity. This corresponds to determining the execution of reinforcement learning in a case where the pleasure degree magnitude V is “high.”

Moreover, the following have also been found: the prediction error of sensory feedback is classified into prediction errors due to a contextual discrepancy and prediction errors due to cognitive conflicts (information discrepancy), and two reactions, namely, curiosity and anxiety, are induced against prediction errors. At this time, memory is facilitated for objects of curiosity, while actions are inhibited for objects of anxiety.

This corresponds to determining the prediction error eₜ from context-based prediction errors and cognition-based prediction errors, as well as determining whether to perform reinforcement learning or not on the basis of the error magnitude k and the pleasure degree magnitude V.

Thus, it can be said that the behavior of the information processing system described with reference to FIG. 2 is close to the human behavior, and according to the present technology, it is possible to achieve an agent (information processing system) that is more human-like in behavior.

In other words, according to the present technology, it is possible to achieve an information processing system that has curiosity toward reinforcement learning and can autonomously determine whether to perform reinforcement learning or not, that is, the start and end of reinforcement learning, as well as autonomously determine the transition (switching) of the target of reinforcement learning.

Here, the context-based prediction error and the cognition-based prediction error are further described.

The context-based prediction error indicates the discrepancy between existing environmental information (past experience) and new environmental information. That is, the context-based prediction error is an error caused by the discrepancy in environmental information.

Specifically, for example, the maps of unfamiliar areas or the like or changes in objects on maps are contextual discrepancies, and a magnitude of such contextual discrepancies is the context-based prediction error.

When a context-based prediction error is calculated, new environmental information is compared with existing environmental information to detect new context or sudden context changes. On the basis of the detection result, the context-based prediction error is determined.

Further, related-art general curiosity models reinforce exploration of new learning targets and do not consider areas explored once as exploration targets (learning targets) in a route search, for example. Thus, there is a possibility that the behavior of such curiosity models may deviate from a human curiosity-based behavior.

In contrast to this, in the information processing system of the present technology configured to perform reinforcement learning on the basis of context-based prediction errors, as described above, exploration is terminated (reinforcement learning is completed) due to boredom, and the action is changed depending on the error magnitude k based on context-based prediction errors.

The change in action here refers to determining whether to execute reinforcement learning or not, in other words, starting or completing reinforcement learning, selecting avoidance actions, and the like.

For example, in a case where the error magnitude k is “small,” reinforcement learning is not performed, that is, exploration (reinforcement learning) is terminated (completed) due to adaptation to the exploration action itself. Further, in a case where the error magnitude k is “medium,” exploration with the curiosity module, that is, reinforcement learning of the learning model, is executed. In a case where the error magnitude k is “large,” an avoidance action is taken through action inhibition.

It can be said that such an information processing system of the present technology is a model configured to exhibit a more human-like behavior compared to general curiosity models.

In the information processing system, context-based prediction errors are utilized to determine whether to perform reinforcement learning or not, thereby making it possible to achieve reinforcement learning that incorporates new changes in external environment, that is, changes in environmental information. That is, in a case where context-based prediction errors are detected, reinforcement learning (update) is performed to obtain a learning model that incorporates changes in environmental information.

Further, the cognition-based prediction error indicates the discrepancy between existing reward information (past experience) and new reward information, particularly, the discrepancy between existing evaluation functions and new evaluation functions. That is, the cognition-based prediction error is an error caused by the discrepancy in evaluation functions.

Specifically, the cognition-based prediction error refers to a measure indicating how much new reward information is new with respect to the evaluation functions used for selected action evaluation performed in the past or objectives or tasks of the actions indicated by reward information.

When a cognition-based prediction error is calculated, the cognition-based prediction error is determined on the basis of the comparison of the gap between a known evaluation function and a new evaluation function, leading to the suppression of the past known information (existing information) and evaluation function refreshing.

In the information processing system of the present technology configured to perform reinforcement learning on the basis of such cognition-based prediction errors, new reward information is recorded through memory updates as described above. Thus, the significance of an existing action objective (existing reward information) is lost due to objective setting corresponding to the recorded new reward information, that is, the objective of the action indicated by the new reward information, with the result that the use of the existing evaluation function (reward information) is reduced.

Further, by utilizing cognition-based prediction errors in the information processing system of the present technology, exploration is terminated (reinforcement learning is completed) due to boredom, and the action is changed depending on the error magnitude k based on cognition-based prediction errors.

For example, in a case where the error magnitude k is “small,” since there is no (zero) or a small cognition-based prediction error, reinforcement learning is not performed, and exploration of new learning (new task) is performed. That is, the learning target is switched.

Further, in a case where the error magnitude k is “medium,” exploration with the curiosity module, that is, reinforcement learning of the learning model, is executed. In a case where the error magnitude k is “large,” an avoidance action is taken through action inhibition.

In the information processing system utilizing cognition-based prediction errors as described above, since reinforcement learning and learning target switching are autonomously performed, it is possible to increase existing evaluation functions (reward information) and expand the objectives of actions.

### Configuration Example of Information Processing System

Next, a configuration example of the information processing system of the present technology, which has been described above, is described.

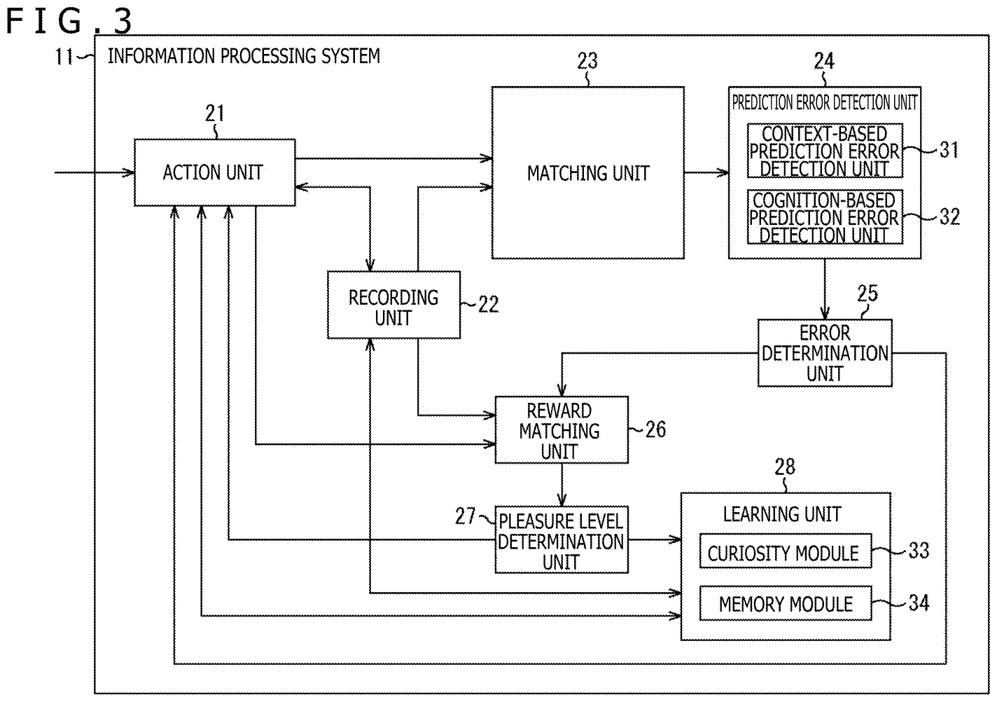

An information processing system 11 illustrated in FIG. 3 includes, for example, a learning model subjected to reinforcement learning and an information processing device that functions as an agent configured to determine actions on the basis of input environmental information or reward information and execute the determined actions.

Note that the information processing system 11 may include a single information processing device or multiple information processing devices.

The information processing system 11 includes an action unit 21, a recording unit 22, a matching unit 23, a prediction error detection unit 24, an error determination unit 25, a reward matching unit 26, a pleasure level determination unit 27, and a learning unit 28.

The action unit 21 acquires externally supplied new input information, supplies the acquired new input information to the matching unit 23 and the recording unit 22, and determines actions on the basis of, for example, the learning model read from the recording unit 22 and the acquired new input information to actually execute the actions.

The recording unit 22 records existing information and updates the existing information by recording the environmental information or reward information supplied as new input information from the action unit 21 and the learning model which has been subjected to reinforcement learning and which is to be supplied from the learning unit 28. Further, the recording unit 22 appropriately supplies the recorded existing information to the action unit 21, the matching unit 23, the reward matching unit 26, and the learning unit 28.

The existing information recorded on the recording unit 22 includes, as described above, the learning model as well as the environmental information, reward information, past selected action information, and the amount of reward given for the action indicated by the selected action information (evaluation result of action), regarding the learning model in each past situation. That is, the learning model included in the existing information is obtained through reinforcement learning based on the existing environmental information or reward information included in that existing information. Further, the environmental information may be any information regarding the surrounding environment of the information processing system 11.

The matching unit 23 matches the new input information supplied from the action unit 21 against the existing information supplied from the recording unit 22, more specifically, the existing environmental information or reward information, that is, matches the new input information against the past memory, and supplies the matching result to the prediction error detection unit 24.

The prediction error detection unit 24 calculates prediction errors. The prediction error calculated by the prediction error detection unit 24 is the prediction error eₜ described above.

The prediction error detection unit 24 includes a context-based prediction error detection unit 31 and a cognition-based prediction error detection unit 32.

The context-based prediction error detection unit 31 calculates a context-based prediction error on the basis of the matching result from the matching unit 23, that is, new environmental information serving as new input information and the environmental information included in the existing information.

The cognition-based prediction error detection unit 32 calculates a cognition-based prediction error on the basis of the matching result from the matching unit 23, that is, new reward information serving as new input information and the reward information included in the existing information.

The prediction error detection unit 24 calculates the final prediction error on the basis of the context-based prediction error calculated by the context-based prediction error detection unit 31 and the cognition-based prediction error calculated by the cognition-based prediction error detection unit 32 and supplies the final prediction error to the error determination unit 25.

The error determination unit 25 determines, on the basis of the prediction error supplied from the prediction error detection unit 24, the magnitude of the supplied prediction error (error magnitude k). That is, the error determination unit 25 determines whether the magnitude of the prediction error (error magnitude k) is “large,” “medium,” or “small.”

Further, depending on the determination result of the magnitude of the prediction error (error magnitude k), the error determination unit 25 instructs the reward matching unit 26 to perform reward (reward information) matching or instructs the action unit 21 to execute an action other than reinforcement learning.

In response to the instruction from the error determination unit 25, the reward matching unit 26 acquires reward information or the like from the action unit 21 or the recording unit 22, performs reward (reward information) matching to calculate the pleasure degree Rd, and supplies the pleasure degree Rd to the pleasure level determination unit 27.

The pleasure level determination unit 27 determines the magnitude of the pleasure degree Rd (pleasure degree magnitude V) supplied from the reward matching unit 26 and instructs the action unit 21 to take an avoidance action or instructs the learning unit 28 to execute reinforcement learning, depending on the determination result.

The learning unit 28 acquires new input information and existing information from the action unit 21 and the recording unit 22, thereby performing reinforcement learning of the learning model, in response to the instruction from the pleasure level determination unit 27.

In other words, the learning unit 28 updates, depending on the error magnitude k or the pleasure degree magnitude V, the existing learning model on the basis of the environmental information or reward information (evaluation function) newly input as new input information and the amount of reward obtained for the action through evaluation with the reward information.

The learning unit 28 includes a curiosity module 33 and a memory module 34.

The curiosity module 33 performs reinforcement learning on the basis of the weighting of learning for reinforcement learning, that is, the parameters for reinforcement learning, determined by the memory module 34, thereby updating the learning model included in the existing information. The memory module 34 determines the weighting of learning (parameters) for reinforcement learning on the basis of the pleasure degree magnitude V.

### <Description of Action Determination Processing>

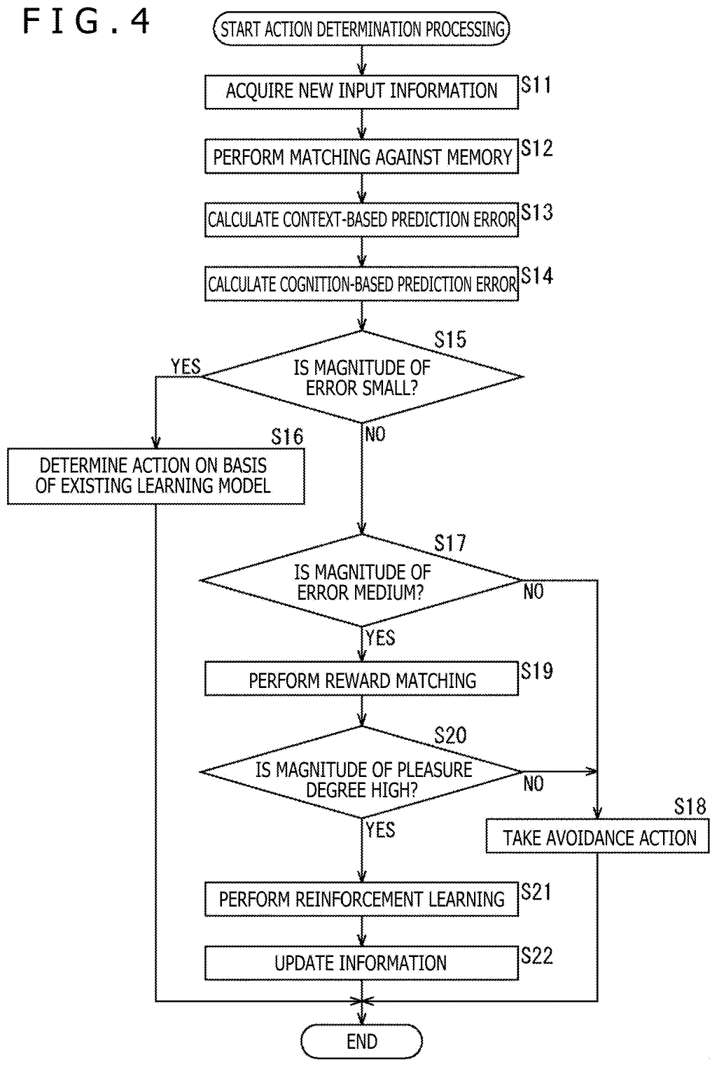

Subsequently, the operation of the information processing system 11 is described. That is, now, with reference to the flowchart of FIG. 4, the action determination processing by the information processing system 11 is described.

In Step S11, the action unit 21 acquires, from the outside, new input information including at least any one of new environmental information and reward information and supplies the new input information to the matching unit 23 and the recording unit 22. The action unit 21 also instructs the recording unit 22 to output existing information corresponding to the new input information.

Then, in response to the instruction from the action unit 21, the recording unit 22 supplies, among the recorded existing information, environmental information or reward information that is most similar (has the highest similarity) to the environmental information or reward information supplied from the action unit 21 as new input information to the matching unit 23 as a past memory.

In Step S12, the matching unit 23 matches the new input information supplied from the action unit 21 against the past memory supplied from the recording unit 22 and supplies the matching result to the prediction error detection unit 24.

In Step S12, for example, matching (comparison) is performed to determine whether or not there is a difference between the environmental information serving as new input information and the existing environmental information serving as a past memory, or matching is performed to determine whether or not there is a difference between the reward information serving as new input information and the existing reward information serving as a past memory.

In Step S13, the context-based prediction error detection unit 31 calculates a context-based prediction error on the basis of the matching result from the matching unit 23, that is, the new environmental information serving as new input information and the environmental information serving as a past memory.

In Step S14, the cognition-based prediction error detection unit 32 calculates a cognition-based prediction error on the basis of the matching result from the matching unit 23, that is, the new reward information serving as new input information and the reward information serving as a past memory.

Further, the prediction error detection unit 24 calculates the final prediction error eₜ on the basis of the context-based prediction error calculated by the context-based prediction error detection unit 31 and the cognition-based prediction error calculated by the cognition-based prediction error detection unit 32 and supplies the prediction error eₜ to the error determination unit 25.

Moreover, the error determination unit 25 compares the prediction error eₜ supplied from the prediction error detection unit 24 with the predetermined threshold ±SD to classify the error magnitude k as “small,” “medium,” or “large.”

Here, as described above, in a case where the prediction error eₜ is less than −SD, the error magnitude k is classified as “small.” In a case where the prediction error eₜ is equal to or greater than −SD and equal to or less than SD, the error magnitude k is classified as “medium.” In a case where the prediction error eₜ is greater than SD, the error magnitude k is classified as “large.”

In Step S15, the error determination unit 25 determines whether the error magnitude k is “small” or not.

In a case where it is determined in Step S15 that the error magnitude k is “small,” the error determination unit 25 instructs the action unit 21 to select an action by using the existing learning model or the like, and then the processing proceeds to Step S16. In this case, reinforcement learning (update) of the learning model is not performed.

In Step S16, in response to the instruction from the error determination unit 25, the action unit 21 determines (selects) the action to be taken next, on the basis of the new input information acquired in Step S11 and the existing learning model and reward information recorded on the recording unit 22.

For example, the action unit 21 performs calculations by inputting, to the existing learning model, the environmental information serving as new input information and the amount of reward determined from the reward information (evaluation function) included in the existing information and determines the action obtained as the output as the action to be taken. Then, the action unit 21 executes the determined action, and the action determination processing is completed. Note that the action indicated by the selected action information included in the existing information as described above may be determined as the action to be taken.

Further, in a case where it is determined in Step S15 that the error magnitude k is not “small,” in Step S17, the error determination unit 25 determines whether the error magnitude k is “medium” or not.

In a case where it is determined in Step S17 that the error magnitude k is not “medium,” that is, the error magnitude k is “large,” the error determination unit 25 instructs the action unit 21 to execute an avoidance action, and then the processing proceeds to Step S18. In this case, reinforcement learning (update) of the learning model is not performed.

In Step S18, the action unit 21 performs the avoidance action in response to the instruction from the error determination unit 25, and the action determination processing is completed.

For example, the action unit 21 performs, as processing corresponding to an avoidance action, the processing of supplying the new input information acquired in Step S11 to an external system and requesting the determination (selection) of an appropriate action corresponding to the new input information. Then, when receiving information that indicates the determined action and is supplied from the external system, the action unit 21 executes the action indicated by the received information.

Further, for example, the action unit 21 may perform, as processing corresponding to an avoidance action, the processing of presenting, to the user, alternative solutions, such as making inquiries to external systems, for resolving a task corresponding to new input information, on a display unit, which is not illustrated, and executing an action in accordance with the instruction input by the user on the basis of the presentation.

Moreover, the action unit 21 may perform, as processing corresponding to an avoidance action, the processing of presenting the action determined by processing similar to that in the case of Step S16 to the user and executing an action in accordance with the instruction input by the user on the basis of the presentation.

Besides, the action unit 21 may perform, as an avoidance action, control to avoid the determination (selection) and execution of actions by the existing learning model.

In cases where the avoidance actions as described above are performed, reinforcement learning of the learning model is not performed, and after execution of the avoidance actions, the processing transitions to exploration of new learning (new task), that is, new reinforcement learning of the learning model.

Further, in a case where it is determined in Step S17 that the error magnitude k is “medium,” the error determination unit 25 instructs the reward matching unit 26 to execute reward (reward information) matching, and then the processing proceeds to Step S19.

In Step S19, the reward matching unit 26 performs reward (reward information) matching to calculate the pleasure degree Rd in response to the instruction from the error determination unit 25 and supplies the pleasure degree Rd to the pleasure level determination unit 27.

That is, the reward matching unit 26 acquires, from the action unit 21, the new input information acquired in Step S11 and reads, from the recording unit 22, the existing environmental information or reward information, selected action information, and evaluation results (amounts of reward) for past selected actions included in the existing information.

Then, the reward matching unit 26 calculates the pleasure degree Rd on the basis of the environmental information or reward information serving as new input information and the existing environmental information or reward information, selected action information, and evaluation results for past selected actions included in the existing information. At this time, the reward matching unit 26 calculates the pleasure degree Rd by also using the negative reward (risk) determined from the reward information or the like.

Further, the pleasure level determination unit 27 compares the pleasure degree Rd supplied from the reward matching unit 26 with the predetermined threshold th to classify the magnitude of the pleasure degree Rd (pleasure degree magnitude V) as “high” or “low.”

Here, as described above, in a case where the pleasure degree Rd is less than the threshold th, the pleasure degree magnitude V is classified as “low,” and in a case where the pleasure degree Rd is equal to or greater than the threshold th, the pleasure degree magnitude V is classified as “high.”

In Step S20, the pleasure level determination unit 27 determines whether the pleasure degree magnitude V is “high” or not.

In a case where it is determined in Step S20 that the pleasure degree magnitude V is not “high,” that is, the pleasure degree magnitude V is “low,” an avoidance action is then taken in Step S18, and the action determination processing is completed.

In this case, reinforcement learning (update) of the learning model is not performed, and the pleasure level determination unit 27 instructs the action unit 21 to execute the avoidance action, and the action unit 21 takes the avoidance action in response to the instruction.

On the other hand, in a case where it is determined in Step S20 that the pleasure degree magnitude V is “high,” the pleasure level determination unit 27 supplies the pleasure degree magnitude V to the learning unit 28 and instructs the learning unit 28 to execute reinforcement learning. Then, the processing proceeds to Step S21. In this case, execution of reinforcement learning has been determined (selected) by the pleasure level determination unit 27.

In Step S21, the learning unit 28 performs reinforcement learning of the learning model in response to the instruction from the pleasure level determination unit 27.

That is, the learning unit 28 acquires, from the action unit 21, the new input information acquired in Step S11 and reads, from the recording unit 22, the existing learning model, environmental information, reward information, selected action information, and evaluation results (amounts of reward) for past selected actions included in the existing information.

Further, the memory module 34 of the learning unit 28 determines the weighting of learning (parameters) for reinforcement learning on the basis of the pleasure degree magnitude V supplied from the pleasure level determination unit 27.

Moreover, the curiosity module 33 of the learning unit 28 performs reinforcement learning of the learning model by using the weighting of learning for reinforcement learning determined by the memory module 34, on the basis of the environmental information or reward information serving as new input information and the existing learning model, selected action information, and the like included in the existing information. That is, the curiosity module 33 performs calculation processing based on the weighting of learning (parameters) to update the existing learning model.

Note that, with regard to reinforcement learning of the learning model, such data as environmental information necessary for reinforcement learning is newly collected as needed. For example, the action unit 21 acquires this data from sensors or the like, which are not illustrated, and supplies the data to the learning unit 28, and the curiosity module 33 of the learning unit 28 performs reinforcement learning by also using the data supplied from the action unit 21.

Through reinforcement learning, as a post-update learning model, there is obtained a learning model configured to take, as inputs, for example, environmental information serving as new input information, actions, and rewards (amounts of reward) for the actions determined from reward information serving as new input information, and outputs the next action and state.

In Step S22, the learning unit 28 updates the information. That is, the learning unit 28 supplies the post-update learning model obtained through reinforcement learning in Step S21 and the environmental information and reward information serving as new input information to the recording unit 22 to record the post-update learning model, the environmental information, and the reward information on the recording unit 22.

When the learning model, the environmental information, and the reward information are recorded and the existing information is updated as described above, the action determination processing is completed.

As described above, the information processing system 11 determines the error magnitude k and the pleasure degree magnitude V when receiving new input information, and depending on the magnitudes of those, autonomously selects actions on the basis of the existing information, performs reinforcement learning, or takes avoidance actions.

In such a way, the information processing system 11 can autonomously determine the execution of reinforcement learning, without relying on external instruction inputs. That is, it is possible to achieve an agent that can automatically switch the learning target and is more human-like in behavior.

### Specific Example

Here, a specific example of reinforcement learning of learning models as described above is described.

Here, as a specific example, there is described a learning model configured to perform a route search (path planning) and output, among routes from a predetermined starting location, such as the current location, to a destination, the most appropriate one that meets the condition (objective of action) indicated by new input information (reward information).

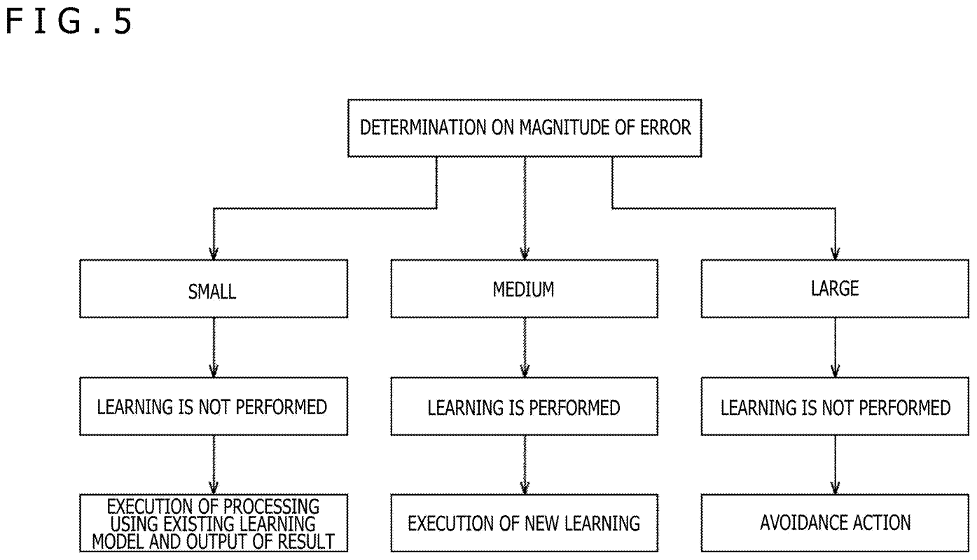

In particular, with respect to such a learning model, a case where only context-based prediction errors indicating a contextual discrepancy are detected and a case where only cognition-based prediction errors indicating a cognitive discrepancy (cognitive conflict) are detected are described with reference to FIG. 5.

First, the case where only context-based prediction errors are detected is described.

In this example, for example, location information regarding a destination such as a hospital, map information (map data) regarding the vicinity of the destination, basic information such as directions and one-way roads regarding the map information, travel time typically required for each route on the map, and information regarding a vehicle configured to travel as an action are regarded as environmental information.

Then, for example, it is assumed that, as a result of a comparison (matching) between environmental information serving as new input information and the environmental information included in the existing information, it has been determined that the map information (map data) has been updated.

In this case, for example, the increase amount (change amount) in detour distance or travel time to the destination caused by the update of the map information, the number of roads requiring route changes, and differences in cities, regions, countries, and traffic rules between the new map information and the existing map information are determined as context-based prediction errors.

In a case where only context-based prediction errors are detected, the prediction error detection unit 24 regards the context-based prediction error, that is, the difference (differential) between the environmental information serving as new input information and the environmental information included in the existing information, as it is as the prediction error eₜ, and regards the magnitude of the prediction error eₜ as the error magnitude k, for example.

Then, in a case where, in the error determination unit 25, the error magnitude k is determined to be “small,” in the information processing system 11, reinforcement learning is not performed, and the existing learning model is used to select an action. That is, processing using the existing learning model is executed and the result is output.

For example, as a case where the error magnitude k is “small,” a case where new map information and existing map information are both map information regarding the same city but the maps indicated by those pieces of map information, that is, roads, buildings, or the like, are slightly different can be considered.

In such a case, the differential in environmental information is sufficiently small, and hence there is a high possibility that the output of the learning model is not changed significantly.

Thus, in the action unit 21, the learning model and reward information included in the existing information, as well as the environmental information serving as new input information, are used to search for a route to the destination, and the route, which is the search result, is presented to the user. Then, when the user provides an instruction for, for example, traveling to the destination, the action unit 21 controls the vehicle to actually travel along the route obtained as a result of the route search, in accordance with that instruction.

Further, for example, in a case where the error magnitude k is determined to be “medium” in the error determination unit 25, in the information processing system 11, reinforcement learning of the learning model is performed. That is, the learning model is updated.

For example, as a case where the error magnitude k is “medium,” the following case can be considered.

That is, in the information processing system 11, there are many experiences in which map information regarding cities has been read as new environmental information, and those pieces of environmental information are recorded as existing information. Then, in the information processing system 11, map information regarding a new city is read as new environmental information (new input information), and a route search in the new city is requested. Such a case can be considered, for example.

In such a case, the differential in environmental information, that is, the magnitude of the context-based prediction error (error magnitude k), is moderate (“medium”), and hence reinforcement learning of the learning model (execution of new learning) is performed.

During reinforcement learning, in the learning unit 28, among routes from the starting location to the destination location, the potentially optimal route that meets the objective indicated by the reward information is determined as a hypothesis on the basis of the new environmental information and the existing learning model and reward information.

Then, the learning unit 28 appropriately collects such data as environmental information necessary for reinforcement learning during the action based on the determined hypothesis, that is, the traveling along the route determined as the hypothesis, through the action unit 21 or the like.

During data collection, for example, environmental information necessary for reinforcement learning is acquired (sensed) by the sensor provided internally or externally to the information processing system 11, or the vehicle is controlled to travel slowly or controlled to travel at different speeds to obtain data under various conditions.

Further, for example, the learning unit 28 acquires an actual travel result (trial result), that is, a reward (amount of reward) for the hypothesis, from a user input or the like or determines the actual travel result from the reward information.

When the information necessary for reinforcement learning, which includes the environmental information, the action (hypothesis), the amount of reward for the action (hypothesis), and the like, is obtained as described above, the learning unit 28 performs reinforcement learning of the learning model on the basis of the obtained information, the existing learning model, the new input information, the existing information, and the pleasure degree magnitude V.

Moreover, for example, in a case where, in the error determination unit 25, the error magnitude k is determined to be “large,” in the information processing system 11, it is determined that it is impossible to perform reinforcement learning to obtain a learning model configured to determine an appropriate action for the new input information, and an avoidance action is taken. That is, in a case where the error magnitude k is determined to be “large,” reinforcement learning is not performed, and an avoidance action is taken.

For example, as a case where the error magnitude k is “large,” the following case can be considered.

That is, in the information processing system 11, there are many experiences in which map information regarding large cities has been read as new environmental information, and those pieces of environmental information are recorded as existing information. In such a state, in the information processing system 11, map information regarding a small local city, a foreign city, or the like is read as new environmental information (new input information), and a route search in the new city is requested. Such a case can be considered, for example.

In such a case, it is difficult to search for an appropriate route by the method using the existing learning model as, for example, the map of the new map information has narrow roads such as mountain trails while the city of the existing map information does not have narrow roads such as mountain trails.

Further, it is difficult to search for an appropriate route by the method using the existing learning model also in a case where, for example, the city of the new map information and the city of the existing map information belong to different countries and have different traffic rules.

Thus, in a case where the error magnitude k is “large,” an avoidance action is taken.

As a specific avoidance action, for example, as described above, the processing of presenting alternative solutions such as making inquiries to external systems to the user and prompting the user to make an appropriate selection can be considered.

Further, for example, the processing of determining an action (searching for a route) on the basis of the existing learning model and reward information, as well as environmental information serving as new input information, and presenting the thus obtained route to the user may be performed as processing corresponding to an avoidance action.

In this case, whether or not to actually perform traveling along the presented route, that is, execution of the action, is left to the user. Further, for example, in a case where traveling (trial) along the presented route is actually performed, the determination of whether or not to use the information obtained for the actual trial and the selected action (route) for subsequent reinforcement learning of the learning model may also be left to the user.

Next, the case where only cognition-based prediction errors are detected is described.

In this example as well, information similar to the example of the case where only context-based prediction errors are detected, that is, location information regarding a destination such as a hospital, map information, and the like are regarded as environmental information.

For example, it is assumed that, as a result of a comparison (matching) between reward information serving as new input information and the reward information included in the existing information, it has been determined that the objective serving as an evaluation function, that is, the objective of the action indicated by the reward information has been changed.

Specifically, as the change in objective, for example, a case where the objective of the action indicated by the reward information is changed from the objective of reaching the destination in the shortest time to the objective of heading toward the destination while minimizing shaking because there is a patient can be considered.

In this example, the objective serving as an evaluation function (the objective of the action indicated by the reward information) is assumed to include not a single condition but multiple conditions, that is, a set of KPIs (Key Performance Indicators).

Specifically, it is assumed that the KPIs indicated by the existing evaluation function are A, B, and C while the KPIs indicated by the new evaluation function are B, C, D, and E.

In such a case, for example, the cognition-based prediction error detection unit 32 calculates, as a cognition-based prediction error, the value obtained by dividing the number of KPIs different between the existing evaluation function and the new evaluation function by the number of KPIs of either the existing evaluation function or new evaluation function whose number of KPIs is greater.

Further, in a case where only cognition-based prediction errors are detected, the prediction error detection unit 24 regards the cognition-based prediction error, that is, the difference between the evaluation function serving as new input information and the evaluation function included in the existing information, as it is as the prediction error eₜ, and regards the magnitude of the prediction error eₜ as the error magnitude k, for example.

Then, in a case where, in the error determination unit 25, the error magnitude k is determined to be “small,” the same processing as in the case of the example in which only context-based prediction errors are detected is performed. That is, reinforcement learning is not performed, and the existing learning model is used to select an action.

Further, for example, in a case where, in the error determination unit 25, the error magnitude k is determined to be “medium,” in the information processing system 11, reinforcement learning of the learning model is performed. That is, the learning model is updated.

Also in a case where the error magnitude k is “medium,” basically the same processing as in the case of the example in which only context-based prediction errors are detected is performed. That is, data necessary for reinforcement learning is appropriately collected and reinforcement learning is performed.

However, during reinforcement learning, reinforcement learning is performed depending on a new evaluation function with use of the collected data such as environmental information and the amount of reward obtained from that new evaluation function. At this time, as needed, with regard to the amount of reward obtained from the new evaluation function, an inquiry regarding, for example, whether the amount of reward is appropriate may be made to the user, or an inquiry regarding, for example, whether an action corresponding to the output of the learning model (correct data) is correct may be made to the user.

Further, during reinforcement learning, whether or not the action (searched route) that serves as the output of the learning model can be evaluated by the new evaluation function is also evaluated.

As described above, in a case where cognition-based prediction errors are detected and the learning model is updated, a learning model configured to evaluate actions on the basis of new evaluation functions can be obtained through reinforcement learning (learning model update).

Moreover, for example, in a case where, in the error determination unit 25, the error magnitude k is determined to be “large,” the same processing as in the case where only context-based prediction errors are detected is performed. That is, reinforcement learning is not performed, and an avoidance action is selected.

As described above, the prediction error eₜ is related to the contextual discrepancy (context-based prediction error) and the cognitive discrepancy (cognition-based prediction error).

In the learning model obtained through reinforcement learning, depending on whether the prediction error eₜ is due to the contextual discrepancy or the cognitive discrepancy, the number or contents of actions that can serve as the output of the learning model, that is, the population of candidate actions, is changed. This is because the objective function (evaluation function) to be satisfied, that is, the KPI or the like, is changed between the contextual discrepancy and the cognitive discrepancy.

Further, for example, in a case where there is a cognitive discrepancy, the options (candidate actions), that is, the output of the learning model, are changed depending on a magnitude of the cognitive discrepancy (cognition-based prediction error).

For example, in a case where the cognition-based prediction error is small, options (candidate actions) that satisfy the existing evaluation function appear. In contrast to this, in a case where the cognition-based prediction error is moderate, since the new conditions (KPIs) are added to the existing conditions (KPIs), the number of candidate actions is small compared to the case where the cognition-based prediction error is small.

### Application Example

The present technology described above can be applied to various technologies.

Specifically, the present technology can be applied, for example, to general control based on online reinforcement learning, picking in factories, robot motion, automated driving, drone control, conversation, recognition systems, and the like.

For example, as examples of control based on online reinforcement learning, the present technology can be applied to motor control for autofocus in digital cameras, motion control for robots and the like, control for other various control systems, and the like.

Further, for example, with regard to picking in factories, using the present technology makes it possible to expand, even when the properties of picking targets, such as shape, softness, and slipperiness, are changed, the range of objects that the machine configured to perform picking can grasp, through reinforcement learning.

Besides, for example, with regard to objectives (goals) of actions, that is, work contents, such as holding picking targets without breaking them, moving picking targets without spilling their contents, and moving picking targets quickly, using the present technology makes it possible to perform tasks ranging from simple one to complex one.

Moreover, applying the present technology to automated driving makes it also possible to perform driving control also using other variables such as data obtained through a CAN (Controller Area Network), for example, behaviors of other vehicles obtained through sensing, a state of the user who is a driver, and information obtained from infrastructure.

Here, the data obtained through a CAN refers to data related, for example, to an accelerator, a brake, a steering wheel, a vehicle tilt, and fuel consumption, and the user's state refers, for example, to stress, drowsiness, fatigue, intoxication, and pleasure, which are obtained on the basis of in-car cameras or biosensors. The information obtained from infrastructure includes, for example, congestion information and information provided by automotive-related services.

Applying the present technology to automated driving makes it possible to improve accuracy in terms of, for example, “not colliding with people” or “avoiding accidents,” and to perform control in specific states on a micro/macro level, such as “ride comfort” or “optimality in a whole urban transportation network,” as well as complex states.

Further, applying the present technology to drone control makes it possible to achieve control based on disturbances such as attitude or wind, terrain data, GPS (Global Positioning System) information, local weather conditions, or the like, improvement of accuracy for predetermined objectives, diversification of objectives, and the swarm control (group control) of drones, and the like.

Moreover, the present technology can also be applied to conversational guide robots, automation of call centers, chatbots, chitchat robots, and the like.

In such cases, it is possible to improve the appropriateness of conversations depending on situations, such as whether the conversation is suitable as a response or is interesting as chitchat, and to achieve a more diverse and flexible response to users and situations, as well as adaptability to changes in situations.

The present technology can also be applied, for example, to recognition-based systems configured to monitor states of the environment, humans, and the like. In such cases, it is possible to achieve not only improvement of accuracy of recognition and the like but also a more diverse and flexible response to users and situations, as well as adaptability to changes in situations.

Further, the present technology can also be applied to general robot control, thereby making it possible to achieve human-like robots and animal-like robots, for example.

More specifically, according to the present technology, for example, it is possible to achieve robots configured to autonomously learn without learning content settings, robots configured to start and complete learning, depending on their interests, and robots configured to remember things of interest and be influenced by their interests in what they remember. Further, for example, according to the present technology, it is possible to achieve robots with curiosity and boredom, robots configured to perform self-monitoring and make efforts or give up, robots of animals such as domestic cats, and other robots.

Besides, the present technology can be applied to support for boredom in learning of humans (human beings), autism models with threshold setting for attention networks, and the like.

### Configuration Example of Computer

Incidentally, the series of processing processes described above can be executed by hardware or software. In a case where the series of processing processes is executed by software, a program configuring the software is installed on a computer. Here, examples of the computer include computers incorporated in dedicated hardware, general-purpose personal computers capable of executing various functions with various programs installed thereon, for example, and other computers.

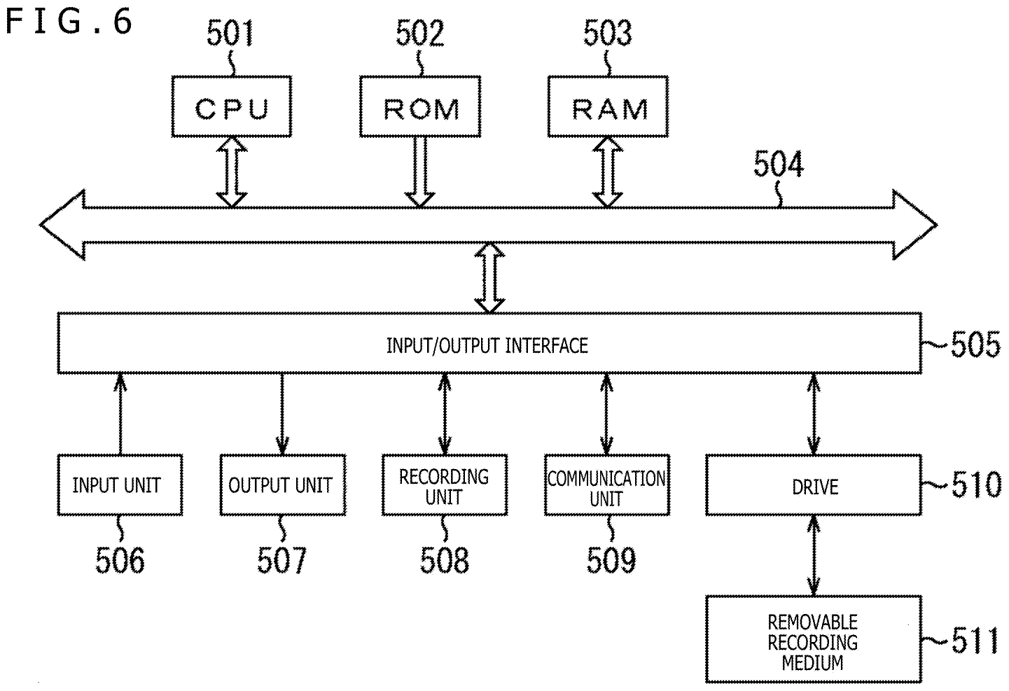

FIG. 6 is a block diagram illustrating a configuration example of hardware of a computer configured to execute the series of processing processes described above by the program.

In the computer, a CPU (Central Processing Unit) 501, a ROM (Read Only Memory) 502, and a RAM (Random Access Memory) 503 are connected to each other through a bus 504.

An input/output interface 505 is further connected to the bus 504. The input/output interface 505 is connected to an input unit 506, an output unit 507, a recording unit 508, a communication unit 509, and a drive 510.

The input unit 506 includes a keyboard, a mouse, a microphone, an imaging element, or the like. The output unit 507 includes a display, a speaker, or the like. The recording unit 508 includes a hard disk, a non-volatile memory, or the like. The communication unit 509 includes a network interface or the like. The drive 510 drives a removable recording medium 511 such as a magnetic disk, an optical disc, a magneto-optical disk, or a semiconductor memory.

In the computer configured as described above, for example, the CPU 501 loads the program recorded on the recording unit 508 into the RAM 503 through the input/output interface 505 and the bus 504 and executes the program to perform the series of processing processes described above.

The program executed by the computer (CPU 501) can be recorded on the removable recording medium 511, which serves as a package medium or the like, to be provided, for example. Further, the program can be provided via a wired or wireless transmission medium such as a local area network, the Internet, or digital satellite broadcasting.

In the computer, the program can be installed on the recording unit 508 through the input/output interface 505 with the removable recording medium 511 mounted on the drive 510. Further, the program can be received by the communication unit 509 via a wired or wireless transmission medium to be installed on the recording unit 508. Besides, the program can be installed on the ROM 502 or the recording unit 508 in advance.

Note that, as for the program executed by the computer, the processing processes of the program may be performed chronologically in the order described herein or in parallel. Alternatively, the processing of the program may be performed at appropriate timings such as when the program is called.

Further, embodiments of the present technology are not limited to the embodiment described above, and various modifications can be made without departing from the gist of the present technology.

For example, the present technology can employ a configuration of cloud computing in which a single function is shared and collaboratively processed by multiple devices via a network.

Further, each step of the flowchart described above can be executed by a single device or shared and executed by multiple devices.

Moreover, in a case where multiple processing processes are included in a single step, the multiple processing processes included in the single step can be executed by a single device or shared and executed by multiple devices.

Moreover, the present technology can also employ the following configurations.

(1)

An information processing system configured to determine an action on a basis of environmental information and a learning model obtained through learning based on an evaluation function for evaluating an action, the information processing system including:
an error detection unit configured to determine a magnitude of a differential between the environmental information that has been newly input or the evaluation function that has been newly input and the environmental information that has existed or the evaluation function that has existed; and
a learning unit configured to update, depending on the magnitude of the differential, the learning model on a basis of the environmental information that has been newly input or the evaluation function that has been newly input and an amount of reward obtained for an action through the evaluation.
   (2)

The information processing system according to (1), further including:
a determination unit configured to determine whether the magnitude of the differential is large, medium, or small, in which the learning unit updates the learning model in a case where the magnitude of the differential is medium.
   (3)

The information processing system according to (2), in which, in a case where the magnitude of the differential is medium, the learning unit updates the learning model, depending on a magnitude of a pleasure degree determined from a difference between the amount of reward based on the environmental information that has been newly input or the evaluation function that has been newly input and the amount of reward based on the evaluation function that has existed.

(4)

The information processing system according to (3), in which the learning unit updates the learning model in a case where the magnitude of the pleasure degree is equal to or greater than a predetermined threshold.

(5)

The information processing system according to (4), in which the learning unit updates the learning model with a weighting depending on the magnitude of the pleasure degree.

(6)

The information processing system according to (4) or (5), in which the learning unit does not update the learning model in a case where the magnitude of the pleasure degree is less than the threshold.

(7)

The information processing system according to any one of (2) to (6), in which the learning unit does not update the learning model in a case where the magnitude of the differential is small.

(8)

The information processing system according to (7), further including:
an action unit configured to determine an action on a basis of the environmental information that has been newly input or the evaluation function that has been newly input and the learning model in a case where the magnitude of the differential is small.
   (9)

The information processing system according to any one of (2) to (8), in which the learning unit does not update the learning model in a case where the magnitude of the differential is large.

(10)

The information processing system according to (9), in which no action is determined by the learning model in the case where the magnitude of the differential is large.

(11)

The information processing system according to any one of (1) to (10), in which the error detection unit determines, as the magnitude of the differential, a magnitude of a context-based error caused by a discrepancy in the environmental information or a magnitude of a cognition-based error caused by a discrepancy in the evaluation function.

(12)

The information processing system according to (11), in which the learning unit performs the update to obtain the learning model based on the evaluation function that has been newly input, in a case where the cognition-based error is detected.

(13)

The information processing system according to (11) or (12), in which the learning unit updates the learning model to reduce use of the evaluation function that has existed, in a case where the cognition-based error is detected.

(14)

The information processing system according to any one of (11) to (13), in which the learning unit performs the update to obtain the learning model that incorporates a change in the environmental information, in a case where the context-based error is detected.

(15)

The information processing system according to any one of (11) to (14), in which the update of the learning model is more likely to be performed in a case where the cognition-based error is detected than in a case where the context-based error is detected.

(16)

An information processing method including:
by an information processing system configured to determine an action on a basis of environmental information and a learning model obtained through learning based on an evaluation function for evaluating an action,
determining a magnitude of a differential between the environmental information that has been newly input or the evaluation function that has been newly input and the environmental information that has existed or the evaluation function that has existed; and
updating, depending on the magnitude of the differential, the learning model on a basis of the environmental information that has been newly input or the evaluation function that has been newly input and an amount of reward obtained for an action through the evaluation.
   (17)

A program for causing a computer, the computer being configured to control an information processing system configured to determine an action on a basis of environmental information and a learning model obtained through learning based on an evaluation function for evaluating an action, to execute processing of:
determining a magnitude of a differential between the environmental information that has been newly input or the evaluation function that has been newly input and the environmental information that has existed or the evaluation function that has existed; and
updating, depending on the magnitude of the differential, the learning model on a basis of the environmental information that has been newly input or the evaluation function that has been newly input and an amount of reward obtained for an action through the evaluation.

### REFERENCE SIGNS LIST

11: Information processing system
21: Action unit
22: Recording unit
23: Matching unit
24: Prediction error detection unit
25: Error determination unit
26: Reward matching unit
27: Pleasure level determination unit
28: Learning unit
31: Context-based prediction error detection unit
32: Cognition-based prediction error detection unit
33: Curiosity module
34: Memory module

1. An information processing system configured to determine an action on a basis of environmental information and a learning model obtained through learning based on an evaluation function for evaluating an action, the information processing system comprising:
an error detection unit configured to determine a magnitude of a differential between the environmental information that has been newly input or the evaluation function that has been newly input and the environmental information that has existed or the evaluation function that has existed; and
a learning unit configured to update, depending on the magnitude of the differential, the learning model on a basis of the environmental information that has been newly input or the evaluation function that has been newly input and an amount of reward obtained for an action through the evaluation.

2. The information processing system according to claim 1, further comprising:
a determination unit configured to determine whether the magnitude of the differential is large, medium, or small,
wherein the learning unit updates the learning model in a case where the magnitude of the differential is medium.

3. The information processing system according to claim 2, wherein, in a case where the magnitude of the differential is medium, the learning unit updates the learning model, depending on a magnitude of a pleasure degree determined from a difference between the amount of reward based on the environmental information that has been newly input or the evaluation function that has been newly input and the amount of reward based on the evaluation function that has existed.

4. The information processing system according to claim 3, wherein the learning unit updates the learning model in a case where the magnitude of the pleasure degree is equal to or greater than a predetermined threshold.

5. The information processing system according to claim 4, wherein the learning unit updates the learning model with a weighting depending on the magnitude of the pleasure degree.

6. The information processing system according to claim 4, wherein the learning unit does not update the learning model in a case where the magnitude of the pleasure degree is less than the threshold.

7. The information processing system according to claim 2, wherein the learning unit does not update the learning model in a case where the magnitude of the differential is small.

8. The information processing system according to claim 7, further comprising:
an action unit configured to determine an action on a basis of the environmental information that has been newly input or the evaluation function that has been newly input and the learning model in a case where the magnitude of the differential is small.

9. The information processing system according to claim 2, wherein the learning unit does not update the learning model in a case where the magnitude of the differential is large.

10. The information processing system according to claim 9, wherein no action is determined by the learning model in the case where the magnitude of the differential is large.

11. The information processing system according to claim 1, wherein the error detection unit determines, as the magnitude of the differential, a magnitude of a context-based error caused by a discrepancy in the environmental information or a magnitude of a cognition-based error caused by a discrepancy in the evaluation function.

12. The information processing system according to claim 11, wherein the learning unit performs the update to obtain the learning model based on the evaluation function that has been newly input, in a case where the cognition-based error is detected.

13. The information processing system according to claim 11, wherein the learning unit updates the learning model to reduce use of the evaluation function that has existed, in a case where the cognition-based error is detected.

14. The information processing system according to claim 11, wherein the learning unit performs the update to obtain the learning model that incorporates a change in the environmental information, in a case where the context-based error is detected.

15. The information processing system according to claim 11, wherein the update of the learning model is more likely to be performed in a case where the cognition-based error is detected than in a case where the context-based error is detected.

16. An information processing method comprising:
by an information processing system configured to determine an action on a basis of environmental information and a learning model obtained through learning based on an evaluation function for evaluating an action,
determining a magnitude of a differential between the environmental information that has been newly input or the evaluation function that has been newly input and the environmental information that has existed or the evaluation function that has existed; and
updating, depending on the magnitude of the differential, the learning model on a basis of the environmental information that has been newly input or the evaluation function that has been newly input and an amount of reward obtained for an action through the evaluation.

17. A program for causing a computer, the computer being configured to control an information processing system configured to determine an action on a basis of environmental information and a learning model obtained through learning based on an evaluation function for evaluating an action, to execute processing of:
determining a magnitude of a differential between the environmental information that has been newly input or the evaluation function that has been newly input and the environmental information that has existed or the evaluation function that has existed; and
updating, depending on the magnitude of the differential, the learning model on a basis of the environmental information that has been newly input or the evaluation function that has been newly input and an amount of reward obtained for an action through the evaluation.
